(19) United States
(12) Patent Application Publication
(10) Pub. No.: US 2024/0174771 A1
(43) Pub. Date: May 30, 2024

(54) INULIN COMPOSITIONS AND PLANT-BASED DAIRY MILK ALTERNATIVE COMPOSITIONS CONTAINING THE SAME

(71) Applicant: WhiteWave Services, Inc., Broomfield, CO (US)

(72) Inventor: Diego J. Rosso Gonzalez, Denver, CO (US)

(21) Appl. No.: 18/072,018

(22) Filed: Nov. 30, 2022

(51) Int. Cl. C08B 37/00; A23C 11/10; A23L 11/65; A23L 33/22

(52) U.S. Cl. CPC C08B 37/0054; A23C 11/103; A23L 11/65; A23L 33/22; A23L 2/66

(57) ABSTRACT

Inulin compositions and plant-based dairy milk alternatives containing these inulin compositions and processes for the preparation and use thereof.

### CROSS REFERENCE TO RELATED APPLICATIONS

None

### FIELD

The invention generally relates to compositions containing inulin polymers that have desirable organoleptic properties and plant-based dairy milk alternatives comprising the same.

### BACKGROUND

Dairy milk products often occupy a central place in human and animal diets globally due to their nutritional blend of proteins, fats, and carbohydrates. With the recognition of certain consequences of industrial dairy, there is a growing interest in plant-based (i.e., plant-derived) milk alternatives for allergenic, consumer preference, and ecological reasons. Unfortunately, many consumers find plant-based milks unpalatable or undesirable in comparison to dairy milk. The objections to plant-based milks may be due to taste, texture, smell, color, (i.e., organoleptic properties) and/or other consumer perceptions of these plant-based compositions.

In addition to their use as nutritional beverages, plant-based milk alternatives can also be used to produce non-dairy creamers, non-dairy yogurts, non-dairy frozen desserts and other food products that traditionally require a dairy milk product base. However, these plant-based milk alternatives often have viscosity, thermodynamic, tensile, surfactant, and aerification properties deemed inferior to dairy milk by many consumers. As a result, dairy milk remains the preferred primary ingredient for many food products, including milk, frozen desserts, creamers, yogurts, and cheeses.

The most common plant-derived milk alternatives are soy, coconut, rice, oat, almond, and other tree-nut based milk alternatives. Known methods for producing these alternatives vary drastically in their processes with some utilizing the whole plant and others just the seed material as their starting material. Some require extensive processing to yield an aqueous or colloidal extract from those source materials. Other methods broadly consist of reconstituting mixtures of isolated and purified macro-nutrients in dry or liquid form.

The taste, texture, and smell of many foods and beverages are intertwined in the overall organoleptic perception and acceptance of the foodstuff, and this is true of dairy milk and their plant-based alternatives. In dairy milk, these organoleptic properties are mostly determined by the sugar and lipid components that determine, amongst other physical characteristics, the viscosity of dairy milks. Viscosity is how tightly a liquid holds together, and in dairy milk results from the ratio of unsaturated to saturated fatty acids. Many plant-derived oils have been tested and used to mimic the viscosity and other physical characteristics (such as dairy milk's ability to emulsify and foam) of plant-based milks in attempts to produce plant-based beverages that are reminiscent of dairy milk and therefore more palatable and acceptable to the consumer.

By comparison, current plant-based milk products typically range in composition from less than 0.5% to about 4% by total weight protein; less than 0.5% to about 3.5% by total weight fat; and less than 0.5% to about 5% by total weight carbohydrates. These products have a much lower percentage by weight of fatty acids than dairy milk, which results in their having different characteristics than dairy milk.

The major protein in dairy milk is casein, and the carbohydrate profile of dairy milk is about 95% lactose. The lipids, in particular unsaturated fatty acids, in dairy milk impart some of the physical and organoleptic characteristics that are difficult to mimic and replicate in alternative milks that rely on plant-based oils, which are typically saturated fatty acids, as replacements for the fatty acids in dairy milk. There remains a need for plant-derived composition(s) that can partially or completely replace the lipid, carbohydrate, and protein components of dairy milk to form plant-based milk alternatives with desirable organoleptic and physical characteristics to gain greater consumer acceptance and use of these products.

### SUMMARY

This disclosure provides texturizing fiber compositions containing inulin, and plant based dairy milk alternative formulations containing these inulin texturizing fibers. These compositions provide organoleptic and physical characteristics closely resembling dairy products and are found acceptable and pleasing to consumers.

It has been discovered, as disclosed herein, that by combining short chain inulins and long chain inulins in specific amounts and ratios, compositions of plant-based fats and proteins can be formulated to resemble organoleptic properties as well as physical characteristics (such as viscosity and coefficient of friction) of whole or reduced-fat dairy milks.

Exemplary plant-based dairy milk alternative compositions of this disclosure include a) water, b) a vegetal fat, c) a plant protein d) an inulin texturizing fiber, and e) a buffering agent, and form dairy milk alternative products having desirable taste and texture. Suitable plant-based dairy milk alternative compositions include 80-99% w/w water; 0.0001-4% w/w a vegetal fat; 0.0001-5% w/w plant protein; and 0.0001%-5% w/w texturizing fiber; 0.0001%-5% w/w buffering agent. These compositions may optionally include 0.001-1% w/w a hydrocolloid agent; 0.0001%-5% w/w a sweetening agent; 0.0001% to 5% w/w a flavor modification agent. The friction coefficient of these compositions may be between 0.2 and 0.6, at 10 mm/s sliding speed.

The plant proteins in these compositions may act as an emulsifier to form an oil in water emulsion. Alternatively or additionally, a separate emulsifying agent, such as soy lecithin, may be added to these compositions.

In a first aspect, this disclosure provides plant-based compositions containing inulin polymers in specific polymer chain length combinations and ratios.

In a second aspect, this disclosure provides plant-based diary milk alternative compositions that include the plant-based compositions containing inulin polymers of the first aspect.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE FIGURES

FIG. 1 shows the viscosity profile of three inulin compositions of this disclosure and whole milk.

FIG. 2 is a depiction of a Stribeck displaying exemplary results of tribology analysis as used in the analysis and characterization of the compositions of this disclosure.

FIG. 3 is a chart depicting the coefficient of friction at different sliding speeds for six common commercial milk products.

### DETAILED DESCRIPTION

The present invention relates to compositions comprising inulin for use in beverages, foods, or nutritional supplements that have organoleptic and physical characteristics that are pleasing to the consumer.

### Definitions

The present invention is not limited to particular components, methods, products or combinations described, as such methods, components, products and combinations may, of course, vary within the spirit of the invention. The terminology used herein is not intended to be limiting, because the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” as used herein include the terms “consisting of”, “consists” and “consists of”, as well as the terms “consisting essentially of”, “consists essentially” and “consists essentially of”.

As used herein, and in the appended claims, the singular forms “a”, “an”, and “the” include plural reference unless the context clearly dictates otherwise. As well, the terms “a” (or “an”), “one or more” and “at least one” can be used interchangeably herein. The terms “comprising”, “including”, “characterized by” and “having” can be used interchangeably.

In the context of this application, unless otherwise provided, amounts refer to amounts by weight. As used herein, the term “x % (w/w)” “x % w/w” is equivalent to “x g per 100 g”. Unless indicated otherwise, all % value shall be taken to indicate x % w/w.

In the context of this application, the term “at least” also includes the starting point of the open range. For example, an amount of “at least 95.00% w/w” means any amount equal to 95.00 percentage by weight or above.

The term “about” or “approximately” as used herein when referring to a measurable value such as a parameter, an amount, a temporal duration, and the like, defines a range of plus or minus 10% of the cited value. For example, an amount of “about 20 weight %” means any amount within the range of 18.00 to 22.00 weight %. The value to which the modifier “about” or “approximately” refers is itself also specifically, and preferably, disclosed.

The recitation of numerical ranges by endpoints includes all numbers and fractions subsumed within the respective ranges, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

As used herein the term “plant-based” shall be taken to mean a composition or product which comprises plant or plant-derived matter but does not comprise animal or animal-derived matter including, but not limited to, dairy, egg, fish, shellfish, meat, dairy milk, and insects.

As used herein the adjective “dairy” shall be taken to mean a composition or product that comprises or consists of mammalian milk matter, i.e., the lacteal secretion obtainable by milking.

As used herein the terms “free” or “free from” shall be taken to mean a composition or product which preferably does not contain a given substance but where trace amounts or contaminants thereof may be present.

As used herein the terms plant-based alternative, analogue, or substitute shall be taken to mean a plant-based food or beverage composition that is formulated to simulate the organoleptic and/or nutritional qualities of an equivalent nonplant-based product.

As used herein, organoleptic properties include sensory properties of a given composition such as, but not limited to, mouthfeel, texture, taste, smell, visual appearance, consistency of the product and physical attributes of a substance that are considered pleasing to the individual consumer.

Inulins belong to a class of fibers known as fructans. Inulins are polymers of linear chains of fructose units connected via β (2-1) glycosidic bond which may have a terminal glucose unit, wherein the number of monosaccharide units in an inulin molecule (commonly referred to as the degree of polymerization) is at least 3. As used herein, the term “inulin” refers to a mixture of oligo- and/or polysaccharides of fructose which may have a terminal glucose. Inulins with a terminal glucose are also referred as alpha-D-glucopyranosyl-[beta-D-fructofuranosyl](n−1)-D-fructofuranosides. Inulins without a terminal glucose are also referred as beta-D-fructopyranosyl-[D-fructofuranosyl](n−1)-D-fructofuranosides. Inulin can be isolated and obtained and are available commercially as liquid or powder products.

As used herein, the term “degree of polymerization” or “DP” relates to the number of monosaccharide residues present in an oligo- or polysaccharide, specifically the inulin polysaccharide. The parameter ‘average degree of polymerization’ is also used in reference to a measure of molecular weight. The DP can be calculated as the ratio of the total MW of the polymer or oligomer and the molecular weight of the repeating units. A suitable method to determine the inulin chain length distribution is by a chromatographic method, such as high-performance anion exclusion chromatography coupled to pulsed amperometric detection (HPAEC-PAD). A preferred method to determine the inulin chain length distribution is in accordance with the HPAEC-PAD protocol. Thus, in embodiments, the methods and products of the invention are provided, having the inulin chain length distribution characteristics as described herein when determined in accordance with the HPAEC-PAD protocol (Timmermans et al. (1994) Quantitative Analysis of the Molecular Weight Distribution of Inulin by Means of Anion Exchange HPLC with Pulsed Amperometric Detection, Journal of Carbohydrate Chemistry, 13:6, 881-888).

Inulins useful in the compositions of the present disclosure may also encompass the hydrolysis products of inulins such as oligofructoses, which are fructose oligomers with a degree of polymerization (DP) of ≤20, and they can also encompass fructose oligomers ending with a terminal glucose with a DP of 3-5 synthesized from saccharose. Suitable oligosaccharide chains of inulin from plant origin useful in the compositions of the present disclosure can have a degree of polymerization (DP) ranging from 3 to about 100.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following description, different aspects of the invention are defined in more detail. Each aspect so defined may be combined with any other aspect or aspects unless clearly indicated to the contrary. Any feature indicated as preferred or advantageous may be combined with any other feature or features indicated as preferred or advantageous.

### Inulin Compositions

This disclosure provides plant-based texturizing fiber compositions comprising inulin that are useful in modifying the organoleptic and physical characteristics of foods or supplements to be acceptable and pleasing to the consumer. This may include the addition of these inulin compositions to foods or supplements or the re-formulation of certain foods or supplements to replace one or more ingredients with the inulin compositions of this disclosure. In particular, the inulin compositions of this disclosure are useful as components of plant-based dairy milk alternatives, and related products such as non-dairy creamers, non-dairy yogurts, non-dairy cheeses, non-dairy frozen desserts, and other food products that traditionally require a dairy milk product base.

The plant-based texturizing fiber compositions of this disclosure comprise a combination of short chain and long chain inulin polymers. The short chain inulin polymers in these plant-based texturizing fiber compositions may have an average DP below about 12, for example between 3 and 12, or between 3 and 10, or between 6 and 10, and for example about 10. The long chain inulin polymers in these plant-based texturizing fiber compositions may have an average DP above about 20, for example between 20 and 60, or between 20 and 40, or between 22 and 30, or between 22 and 27, and for example about 22. The inulin polymers in these plant-based texturizing fiber compositions may have short and long chain inulin present in a w/w ratio of 1:0.15-2:1 (short chain inulin:long chain inulin).

The plant-based texturizing fiber compositions of this disclosure may contain no, or substantially no, inulin polymers that have an average DP between 10 and 22, for example between 12 and 20 (i.e., the compositions may be substantially free of inulin polymers that have an average DP between 12 and 20). Thus, the plant-based texturizing fiber compositions of this disclosure may contain less than 1%, or less than 0.5%, or less than 0.1%, or less than 0.01%, or less than 0.001% inulin polymers that have an average DP between 10 and 22, for example an average DP between 12 and 20.

The inulin-containing compositions of this disclosure may be formed as an aqueous composition or may be formed as an emulsion with fats, fatty acids, emulsifying agents, and/or other edible ingredients. Inulin may be obtained as a liquid or a solid and is available from numerous commercial sources. Inulin for use in preparing the texturizing fiber compositions of this disclosure is preferably obtained from plant sources. For example, inulin has been obtained and characterized from juice obtained after extraction of sliced chicory roots (Berghofer et al. “Pilot-scale production of inulin from chicory roots and its use in foodstuffs.” Studies in Plant Science. 1993, 3:77-84). U.S. Pat. No. 5,968,365 discloses a process for separating a first aqueous inulin solution containing carbohydrates having a range of degrees of polymerization into fractions having different average degrees of polymerization, which process comprises subjecting an aqueous inulin solution to ultrafiltration through a membrane having a predetermined pore size whereby inulin fractions having average degrees of polymerization less than a predetermined value pass through into the membrane permeate and inulin fractions having average degrees of polymerization greater than a predetermined value are collected as retentate. U.S. Pat. No. 5,254,174 discloses physical separation processes to reduce the amount of fructose, glucose, and sucrose in a juice or syrup comprising fructose, glucose, sucrose, and oligosaccharides. CN102504048, CN106947006, and CN108424478 disclose processes wherein aqueous inulin extracts are purified using a process comprising ion-exchange treatment. EP0787745A2 discloses processes wherein aqueous inulin extracts with DP>40 are removed, followed by ion-exchange treatment.

Thus, inulin for use in the compositions of this disclosure can originate from or be isolated or obtained from any natural source of inulin, or can be enzymatically synthesized from saccharose, or can be a commercially available inulin. But preferred sources of inulin for use in the compositions of this disclosure originate from or are isolated from elecampane, dandelion, dahlia, wild yam, artichoke, Jerusalem artichokes, chicory, jicama, burdock, onion, garlic, agave, yacón, banana, leek, asparagus, or camas. More preferably, the inulin originates from, or is isolated from, chicory or Jerusalem artichokes. Suitable commercial inulin for use in the compositions of this disclosure include Fibruline® Instant, Fibruline® XL, Fibruline® DS, Fibruline® S20, Fibrulose® F97 (Cosucra Group Warcoing SA, Belgium), Orafti® ST, Orafti® GR, Orafti® LGI, Orafti® HSI, Orafti® P95, Orafti® L85, Orafti® L60, Orafti® synergy1, Orafti® HP (Beneo-Orafti, Belgium), Actilight® 950P, Actilight® 950S, Actilight® 850S (Syral, France).

In the plant-based texturizing fiber compositions of this disclosure, the chain length distribution of the inulins may be formulated such that about 0.15-1.5%, preferably about 0.5%, of the composition is inulin having a DP within the range of 20-60, preferably within the range of 20-30. Alternatively or additionally, in the plant-based texturizing fiber compositions of this disclosure, the chain length distribution of the inulins may be formulated such that about 0.5-1.5%, preferably about 1.0%, of the composition is inulin having a DP within the range of 3-10, preferably within the range of 6-10.

In the plant-based texturizing fiber compositions of this disclosure, the short and long chain inulin may be present in a w/w ratio of 1:0.15 to 2:1 (short chain inulin:long chain inulin). The coefficient of friction at 10 mm/s of these compositions may be about 0.2 to about 0.6.

These texturizing fiber compositions may optionally include one or more of a protein, a sweetener, and a fat. In such inulin compositions containing a fat, the fat may be a vegetal oil, for example, coconut oil, sunflower oil, almond oil, and/or palm oil. In such compositions containing a protein, the protein may be a plant protein derived from a plant source, such as peas, chickpeas, soybeans, yellow peas, rice, hemp, quinoa, almonds, and/or wheat. In such inulin compositions containing a sweetener, the sweetener may be glucose, agave, cane juice, honey, sucralose, aspartame, and/or saccharine.

### Plant-Based Dairy Milk Alternative Compositions

Another aspect of this disclosure provides plant based dairy milk alternative compositions.

Accordingly, embodiments described herein provide compositions comprising a) water, b) vegetal fat(s), c) plant protein(s) and d) buffering agent(s).

The plant based dairy milk alternative compositions disclosed herein may optionally further comprise e) hydrocolloid agent(s), f) sweetening agents, and/or g) flavor modifying agent(s).

These plant-based dairy milk alternative compositions may be aqueous compositions, including, for example, oil in water emulsions. The friction coefficient of these compositions may be between about 0.2 and about 0.6, at 10 mm/s sliding speed, or between 0.3 and 0.5, at 10 mm/s sliding speed. The viscosity of these compositions may be between about 45 mPa·s and about 55 mPa·s, at 1 s₋₁, or between 49 mPa·s and about 52 mPa·s, at 1 s⁻¹ as measured using a conical plate viscometer. The viscosity of these compositions may be between about 2.9 mPa·s and about 3.5 mPa·s, at 1000 s⁻¹, or between 3.1 mPa·s and 3.3 mPa·s, at 1000 s⁻¹ as measured using a conical plate viscometer.

In these plant-based dairy milk alternative compositions, the texturizing fiber includes the plant-based texturizing fiber compositions comprising a combination of long chain and short chain inulin, as described above, wherein the short chain inulin polymers may have an average DP below about 12, for example between 3 and 12, or between 3 and 10, or between 6 and 10, and, for example, about 10; and the long chain inulin polymers may have an average DP above about 20, for example between 20 and 60, or between 20 and 40, or between 22 and 30, or between 22 and 27, and, for example, about 22; and wherein the short and long chain inulins may be present within the texturizing fiber in a w/w ratio of between 1:0.15 and 2:1.

In these compositions, the texturizing fiber may contain no, or substantially no, inulin polymers that have an average DP between 10 and 22, for example between 12 and 20. Thus, the plant-based texturizing fiber in these dairy milk alternative compositions may contain less than 1%, or less than 0.5%, or less than 0.1%, or less than 0.01% inulin polymers that have an average DP between 10 and 22, for example between 12 and 20.

These dairy milk alternative compositions are typically in the form of an emulsion of vegetal oil droplets in an aqueous phase. These compositions typically have a uniform distribution of particles within the aqueous phase, during shelf-life, for example during up to 7, 30, 60 or 90, 120, 150, 180, 210, or 240 days storage at a chilled temperature of 0° C. to 10° C., or at ambient (“room”) temperature, for example, from 15° C. to 25° C.

The pH of these dairy milk alternative compositions may be at most 9.5, for example, from 7 to 9.5 or from 8.5 to 9.5.

### a) Water

The stable compositions disclosed herein comprise water. Water is typically present in an amount balancing the amounts of other ingredients to 100% by weight. In an embodiment water is present in an amount between 40% and 90% by weight, for example, or from 60% to 90%, or from 40% to 45% or from 45% to 50% or from 50% to 55% or from 55% to 60% or from 60% to 65% or from 65% to 70% or from 70% to 75%, or from 75% to 80% or from 80% to 85% or from 80% to 85%. In one embodiment the water quality is monitored to ensure sufficiently low level of cations to ensure emulsification stability is not impacted. The total cation content can be less than about 60 ppm (40 ppm for divalent ions and 20 ppm for monovalent ions) and the hardness of water can be 6 gram/gallon or less.

### b) Vegetal Fat

As used herein the term “vegetal” shall be taken to mean edible parts of a plant including but not limited to vegetables, fruits, flowers, stems, seeds, leaves, and roots.

The stable compositions disclosed herein comprises at least one vegetal fat. Suitable examples of such fats are vegetal oils including, but not limited to, coconut oil, canola oil, soybean oil, sunflower oil, safflower oil, palm oil, palm kernel oil, olive oil, avocado oil and/or mixtures or combinations thereof. The vegetal oils may be selected from the group consisting of coconut oil, palm oil, palm kernel oil, and/or mixtures or combinations thereof. The vegetal oils may be a combination of coconut oil and sunflower oil. The vegetal fat may be coconut oil in higher concentrations, in embodiments the coconut oil may be provided in the form of or derived from coconut cream.

In one embodiment the vegetal fat is present in an amount of from 1% to 10% by weight, for example, from 2% to 8%, or from 2.5% to 9%, or from 2.9% to 8%, or from 3% to 7%, or from 2.5% to 3.5%. Compositions with such amounts of vegetal fat present good organoleptic properties.

### c) Plant Protein

The plant-based dairy milk alternative compositions disclosed herein comprise at least one plant protein. In some embodiments, the plant protein source comprises or consists of legume, for example pulse or pulses. The plant protein source may be selected from the group consisting of lentils, chickpeas, peas, beans and/or combinations thereof. The plant protein sources may be selected from the group consisting of, soy beans, yellow peas, green peas, split peas, field peas, dry peas, lentil, chickpea/garbanzo bean, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, lupin and/or mixtures or combinations thereof. In embodiments, the plant protein source comprises soybean protein.

Plant protein ingredients are known in the art and are commercially available. Plant protein ingredients can be, for example, a plant protein isolate, concentrate, or flour.

The term “protein concentrate,” as used herein, generally refers to protein derived from plant source that has been extracted from the plant source and purified. Protein concentrate may comprise greater than or equal to about 40%, 50%, 60%, 70%, or 80%, or more total protein on a dry matter basis. The protein concentration of the protein concentrate may be increased by greater than or equal to about 20%, 30%, 40%, 50%, 60%, 70%, 80%, or more than the protein concentration of the plant. A protein concentrate may comprise a single type of protein or a combination of different types of proteins.

The term “protein isolate,” as used herein, generally refers to protein derived from a plant source that has been extracted from the plant source and purified. A protein isolate may have a higher purity than a protein concentrate. A protein isolate may be formed by further processing a protein concentrate to increase the protein concentration. Protein isolate may comprise greater than or equal to about 80%, 90%, 95%, or more protein on a dry matter basis.

The plant protein in these compositions may be entirely from, or a portion of, a plant component of the composition. Non-limiting examples include oils or pastes or powders of almonds, coconuts, or soybeans, all of which may contain plant proteins and may be added as components of the plant-based dairy milk alternative compositions disclosed herein, without being added, specifically, as a protein concentrate or isolate.

In these compositions, the plant protein may not have been subjected to a hydrolysis step.

In these compositions, the plant protein is present in an amount of from 0.0001% to 5% by weight, for example, from 0.25% to 2.5%, or from 0.5% to 2%. For example, faba bean protein isolate having 90% protein content was found to work well at 1%, 1.4%, 1.5% and 2% in the stable compositions described herein. Soy protein isolate worked well in these compositions in a range of from 0.1% to 2%, in particular an amount of about 0.5%. Surprisingly, pea protein isolate with a 90% protein content at 0.8% and 1.5% did not work well and the composition separated at ambient conditions.

### d) Buffering Agents

The plant-based dairy milk alternative compositions disclosed herein comprise at least one buffering agent. Examples of such buffering agents include monophosphates, diphosphates, sodium mono- and bicarbonates, potassium mono- and bicarbonates, for example, potassium phosphate, dipotassium phosphate, potassium polyphosphates, sodium bicarbonate, trisodium citrate (also referred to as sodium citrate), sodium phosphate, disodium phosphate, trisodium phosphate and sodium polyphosphates, sodium bicarbonate, calcium carbonate and/or mixtures or combinations thereof.

The buffering agent can be provided in an amount sufficient to provide the pH of the composition of at most 9.5, for example, from 7 to 9.5 or from 8.5 to 9.5. Advantageously, the use of a buffering agent can contribute to product stability without impacting organoleptic properties and consumer perception. In one embodiment the buffering agent is present in an amount of from 0.0001% to 5% by weight, for example, from 0.2% to 1%. The buffering agent in these compositions may be dipotassium phosphate present in an amount of about 0.3%.

### e) Hydrocolloid Agent

The plant-based dairy milk alternative compositions disclosed herein optionally may include at least one hydrocolloid agent. Suitable examples include, but are not limited to, hydrocolloids including locust bean gum (aka carob gum), xanthan gum, tragacanth, gum Arabic, acacia gum or gellan gum. Such compounds are known in the art and are commercially available. Gellan gum can be, for example, a high acyl gellan gum.

These compositions may comprise a single hydrocolloid agent.

The hydrocolloid may be present in these compositions in an amount of from 0.001% to 1% by weight, for example, from 0.01% to 0.1%, or from 0.01% to 0.05%, or from 0.02% to 0.04%, or about 0.04%.

### f) Sweetening Agent

The plant-based dairy milk alternative compositions disclosed herein optionally may include at least one sweetening agent. Such sweetening agent may contribute to the consumer perceived sweetness properties of the composition. It may also provide texturizing properties to the composition. The sweetening agent may be, but is not limited to, oat concentrate (hydrolyzed oat extract), sucrose, fructose, saccharose, glucose, maltodextrin, dextrose, sorbitol, xylitol, corn syrup, or a mixture thereof. A corn syrup sweetening agent may be, for example, a high fructose corn syrup, a corn syrup solid, cane sugar, beetroot sugar, honey, agave, maple syrup, or a combination thereof. The sweetening agent may be a mixture of at least two of sucrose, fructose, saccharose, glucose, maltodextrin, dextrose, sorbitol, xylitol, oat concentrate, and a corn syrup (for example, a high fructose corn syrup, a corn syrup solid, cane sugar, beetroot sugar, honey, agave, maple syrup).

The sweetening agent may be is present in these compositions in an amount of from 0.1% to 10%, by weight. For example, the amount of the sweetening agent may be from 0.5% to 5%, or from 0.8% to 1.5%, or from 0.8% to 1.2%, or about 1.5%.

### g) Flavor Modification Agents

The plant-based dairy milk alternative compositions disclosed herein optionally may include at least one flavor modification agent, which is different from the sweetening agent. These flavoring agents typically affect the taste of the composition, and the amount thereof in the composition is usually determined according to a taste that is desired. Examples of flavor modification agents that are useful in these compositions may include, but are not limited to, salts, sweeteners, flavors, flavor modifiers, fruits, fruit extracts, and combinations thereof. Popular flavor modification agents that may be used in these compositions include, for example, vanilla flavor or extract, dairy artificial flavor, hazelnut artificial flavor, amaretto, cinnamon, chocolate, caramel. Suitable ranges for an optional flavor modification agent are from 0.0001% to 5% w/w, e.g., from 0.05% to 3%, from 0.1% to 2%, etc. Examples of flavor-modifying salts include sodium chloride, for example, sea salt. Sea salt can be added from 0.0001 to 2.5%, e.g., 0.05%.

### Packaging

The plant-based dairy milk alternative compositions disclosed herein are typically packaged in a container. The container is then typically sealed, for example, with a gable top, cap, and/or flexible lid. The container may, for example, have a holding capacity or volume of up to 3 kg or 3 L, 2 kg or 2 L, for example, up to 1.5 kg or 1.5 L, for example, up to 1.0 kg or 1.0 L (including, for example a 32 oz or 909 ml container), for example, up to 500 g or 500 mL, for example, up to 250 g or 250 mL, for example, up to 125 g or 125 mL, for example, up to 100 g or 100 mL, for example, up to 50 g or 50 mL, for example, up to 25 g or 25 mL. The container might provide one or several servings. Containers of up 250 g or 250 mL, preferably up to 100 g or 100 mL, typically provide a single serving. The container can be a bottle or a cup, for example, a plastic thermoformed cup. The sealing can be provided by a gable top, flexible lid, and/or or plastic cap. The flexible lid can be, for example, thermosealed to or on the opening of the bottle or cup. The container can be a small single cup, for example, of from 5 g or 5 mL to 15 g or 15 mL, and, for example, sealed with a flexible lid. Such small single cups can be offered alone or grouped in a secondary packaging.

The plant-based dairy milk alternative compositions disclosed herein in the container can be stored, transported and/or distributed at a chilled temperature of 0° C. to 10° C., or at ambient (“room”) temperature, for example, from 15° C. to 25° C.

The plant-based dairy milk alternative compositions disclosed herein may be free from additives such as modified starches, stabilizers, whitening agents, and combinations thereof.

The plant-based dairy milk compositions of this disclosure may be used as a food or beverage, or as an additive in the production of a food or beverage, or as a basis for a food supplement.

### Processes for the Preparation of Inulin-Containing Compositions

Another aspect of this disclosure provides processes for the preparation of the inulin-containing compositions of this disclosure.

The inulin compositions of the present disclosure may be prepared by any known or otherwise effective manufacturing technique for preparing the liquid compositions. Many such techniques are known for consumable liquid products and can easily be applied by one of ordinary skill in the art to the inulin-containing compositions described herein. The compositions of the present disclosure can therefore be prepared by any of a variety of known or otherwise effective formulation or manufacturing methods. In one suitable manufacturing process, for example the plant-based dairy milk alternative compositions disclosed herein can be prepared by mixing the enumerated components together with water up to 100% weight to form a liquid mixture. The liquid mixture may be homogenized, direct heat treated, and homogenized a second time before being aseptically packaged for room temperature or refrigerated storage.

Processes for preparing liquid inulin-containing compositions of this disclosure may include the steps: Composition ingredients may be mixed using a high shear mixer. This mixing may be done hot or cold. Oil ingredients to be added to the mixture may be pre-sheared prior to addition to the mixture. When mixing in hot temperatures, the high temperature melting fat(s) ingredients can be added directly to the mixture. Alternatively, when mixing cold, the high temperature melting fat(s) may be added via oil injection prior to thermal processing, UHT direct or indirect. The liquid mixture may then be run through a high shear device such as a colloid mill shear pump, which may be in recirculation with the high shear mixer. The mixture may then be passed through a homogenizer. Alternatively or additionally, the mixture may then be cooled for holding prior to thermal treatment(s). The mixture is pre-heated prior to thermal processing treatment, which may be direct steam injection, direct steam infusion, or indirect heating UHT. The mixture is then cooled (via a flash cooling or heat exchanger) and homogenized again. The mixture is then cooled further to the filling temperature and filled aseptically or to chilled/extended shelf-life packaging.

The following paragraphs, enumerated consecutively from 1 through 74 provide various exemplary aspects of the present disclosure.

1. In this first paragraph, the present disclosure provides a plant-based texturizing fiber composition comprising a combination of long chain and short chain inulin.

2. The texturizing fiber composition of paragraph 1, wherein the long chain inulin has an average degree of polymerization (DP) greater than 20.

3. The texturizing fiber composition of paragraphs 1 or 2, wherein the long chain inulin has an average degree of polymerization (DP) within the range of 20 to 60.

4. The texturizing fiber composition of any one of paragraphs 1-3, wherein the long chain inulin has an average degree of polymerization (DP) within the range of 20 to 40.

5. The texturizing fiber composition of any one of paragraphs 1-4, wherein the long chain inulin has an average degree of polymerization (DP) within the range of 22 to 30.

6. The texturizing fiber composition of any one of paragraphs 1-5, wherein the long chain inulin has an average degree of polymerization (DP) within the range of 22 to 27.

7. The texturizing fiber composition of any one of paragraphs 1-6, wherein the short chain inulin has an average degree of polymerization (DP) less than 12.

8. The texturizing fiber composition of any one of paragraphs 1-7, wherein the short chain inulin has an average degree of polymerization (DP) within the range of 3 to 12.

9. The texturizing fiber composition of any one of paragraphs 1-8, wherein the short chain inulin has an average degree of polymerization (DP) within the range of 3 to 10.

10. The texturizing fiber composition of any one of paragraphs 1-9, wherein the short chain inulin has an average degree of polymerization (DP) within the range of 6 to 10.

11. The texturizing fiber composition of any one of paragraphs 1-10, wherein the long chain inulin comprises about 0.15% to about 1.5% of the composition.

12. The texturizing fiber composition of any one of paragraphs 1-11, wherein the long chain inulin comprises about 0.5% of the composition.

13. The texturizing fiber composition of any one of paragraphs 1-12, wherein the short chain inulin comprises about 0.5% to about 1.5% of the composition.

14. The texturizing fiber composition of any one of paragraphs 1-13, wherein the short chain inulin comprises about 1.0% of the composition.

15. The texturizing fiber composition of any one of paragraphs 1-14, wherein the short and long chain inulin are present in a w/w ratio of 1:0.15-2:1.

16. The texturizing fiber composition of any one of paragraphs 1-15, wherein the inulin is obtained from a plant selected from the group comprising elecampane, dandelion, dahlia, wild yam, artichoke, Jerusalem artichokes, chicory, burdock, onion, garlic, agave, yacón, banana, leek, asparagus, camas, or a mixture thereof.

17. The texturizing fiber composition of any one of paragraphs 1-16, wherein the composition is an aqueous composition.

18. The texturizing fiber composition of any one of paragraphs 1-17, further comprising one or more of a protein, a sweetener, and a fat.

19. The texturizing fiber composition of any one of paragraphs 1-18, wherein the fat is a vegetal oil selected from coconut oil, sunflower oil, almond oil, and palm oil.

20. The texturizing fiber composition of any one of paragraphs 1-19, wherein the protein is a plant protein derived from a plant source selected from peas, chickpeas, soybeans, yellow peas, rice, hemp, quinoa, almonds, and wheat.

21. The texturizing fiber composition of any one of paragraphs 1-20, wherein the sweetener is selected from glucose, agave, cane juice, honey, sucralose, aspartame, and saccharine.

22. The texturizing fiber composition of any one of paragraphs 1-21, wherein the coefficient of friction at 10 mm/s of the composition is about 0.2 to about 0.6.

23. A plant-based dairy alternative food product comprising the agent of any one of paragraphs 1-22.

24. The plant-based dairy alternative food product of paragraph 23 that is a dairy free milk.

25. The plant-based dairy alternative food product of paragraph 23 that is a dairy free cheese.

26. The plant-based dairy alternative food product of paragraph 23 that is a dairy free yogurt.

27. A plant-based dairy milk alternative composition comprising:
a) 80-99% w/w water;
b) 0.0001-4% w/w a vegetal fat;
c) 0.0001-5% w/w a plant protein; and
d) 0.0001%-5% w/w a texturizing fiber comprising a combination of long chain and short chain inulin;
e) 0.0001%-5% w/w a buffering agent;
f) optionally, 0.001-1% w/w a hydrocolloid agent;
g) optionally, 0.0001%-5% w/w a sweetening agent;
h) optionally, 0.0001% to 5% w/w a flavor modification agent,
wherein the friction coefficient of the composition is 0.2-0.6 at 10 mm/s sliding speed.

28. The plant-based dairy milk alternative composition of paragraph 27, wherein the composition is an oil in water emulsion.

29. The plant-based dairy milk alternative composition of paragraph 27 or 28, wherein the friction coefficient of the composition is 0.3-0.5 at 10 mm/s sliding speed.

30. The plant-based dairy milk alternative composition of any one of paragraphs 27-29, wherein the viscosity of the composition is between about 45 mPa·s and about 55 mPa·s, at 1 s⁻¹ as measured using a conical plate viscometer

31. The plant-based dairy milk alternative composition of any one of paragraphs 27-30, wherein the viscosity of the composition is between about 2.9 mPa·s and about 3.5 mPa·s, at 1000 s⁻¹ as measured using a conical plate viscometer

32. The plant-based dairy milk alternative composition of any one of paragraphs 27-31, wherein the long chain inulin has an average degree of polymerization (DP) greater than 20.

33. The plant-based dairy milk alternative composition of any one of paragraphs 27-32, wherein the long chain inulin has an average degree of polymerization (DP) within the range of 20 to 60.

34. The plant-based dairy milk alternative composition of any one of paragraphs 27-33, wherein the long chain inulin has an average degree of polymerization (DP) within the range of 20 to 40.

35. The plant-based dairy milk alternative composition of any one of paragraphs 27-34, wherein the long chain inulin has an average degree of polymerization (DP) within the range of 22 to 30.

36. The plant-based dairy milk alternative composition of any one of paragraphs 27-35, wherein the long chain inulin has an average degree of polymerization (DP) within the range of 22 to 27.

37. The plant-based dairy milk alternative composition of any one of paragraphs 27-36, wherein the short chain inulin has an average degree of polymerization (DP) less than 12.

38. The plant-based dairy milk alternative composition of any one of paragraphs 27-37, wherein the short chain inulin has an average degree of polymerization (DP) within the range of 3 to 12.

39. The plant-based dairy milk alternative composition of any one of paragraphs 27-38, wherein the short chain inulin has an average degree of polymerization (DP) within the range of 3 to 10.

40. The plant-based dairy milk alternative composition of any one of paragraphs 27-39, wherein the short chain inulin has an average degree of polymerization (DP) within the range of 6 to 10.

41. The plant-based dairy milk alternative composition of any one of paragraphs 27-40, wherein the long chain inulin comprises about 0.15% to about 1.5% of the composition.

42. The plant-based dairy milk alternative composition of any one of paragraphs 27-41, wherein the long chain inulin comprises about 0.5% of the composition.

43. The plant-based dairy milk alternative composition of any one of paragraphs 27-42, wherein the short chain inulin comprises about 0.5% to about 1.5% of the composition.

44. The plant-based dairy milk alternative composition of any one of paragraphs 27-43, wherein the short chain inulin comprises about 1.0% of the composition.

45. The plant-based dairy milk alternative composition of any one of paragraphs 27-44, wherein the short and long chain inulin are present in a w/w ratio of 1:0.15
2:1.

46. The plant-based dairy milk alternative composition of any one of paragraphs 27-45, wherein the inulin is obtained from a plant selected from the group comprising elecampane, dandelion, dahlia, wild yam, artichoke, Jerusalem artichokes, chicory, burdock, onion, garlic, agave, yacön, banana, leek, asparagus, camas, or a mixture thereof.

47. The plant-based dairy milk alternative composition of any one of paragraphs 27-46, wherein the composition is an aqueous composition.

48. The plant-based dairy milk alternative composition of any one of paragraphs 27-47, wherein the coefficient of friction at 10 mm/s of the composition is about 0.2 to about 0.6.

49. The plant-based dairy milk alternative composition of any one of paragraphs 27-48, wherein the water is present in the composition in an amount between 40% and 90% by weight.

50. The plant-based dairy milk alternative composition of any one of paragraphs 27-49, wherein the water in the composition comprises a total cation content less than about 60 ppm.

51. The plant-based dairy milk alternative composition of any one of paragraphs 27-50, wherein the water is present in the composition in an amount between 40% and 90% by weight.

52. The plant-based dairy milk alternative composition of any one of paragraphs 27-51, wherein the vegetal fat is a vegetal oils selected from the group consisting of coconut oil, canola oil, soybean oil, sunflower oil, safflower oil, palm oil, palm kernel oil, olive oil, avocado oil, and combinations thereof.

53. The plant-based dairy milk alternative composition of any one of paragraphs 27-52, wherein the vegetal fat is a combination of coconut oil and sunflower oil.

54. The plant-based dairy milk alternative composition of any one of paragraphs 27-53, wherein the vegetal fat is present in the composition in an amount between 1% and 10% by weight.

55. The plant-based dairy milk alternative composition of any one of paragraphs 27-54, wherein the vegetal fat is present in the composition in an amount between 2.5% and 3.5% by weight.

56. The plant-based dairy milk alternative composition of any one of paragraphs 27-55, wherein the plant protein is protein from a plant source selected from the group consisting of soy beans, yellow peas, green peas, split peas, field peas, dry peas, lentil, chickpeas/garbanzo bean, navy bean, white navy bean, white pea bean, pea bean, cow pea, horse bean, haricot, pinot bean, mottled bean, small red bean, red Mexican bean, kidney bean, black bean, black turtle bean, cranberry bean, roman bean, speckled sugar bean, lima bean, haba bean, Madagascar bean, green gram, mung bean, green bean, black gram, urad dal, lupin and/or mixtures or combinations thereof.

57. The plant-based dairy milk alternative composition of any one of paragraphs 27-56, wherein the plant protein is protein from soybeans.

58. The plant-based dairy milk alternative composition of any one of paragraphs 27-57, wherein the plant protein is a soy protein isolate.

59. The plant-based dairy milk alternative composition of any one of paragraphs 27-58, wherein the plant protein is present in the composition in an amount between 0.1% to 2% by weight.

60. The plant-based dairy milk alternative composition of any one of paragraphs 27-59, wherein the plant protein is a soy protein isolate present in the composition in an amount of about 0.5% by weight.

61. The plant-based dairy milk alternative composition of any one of paragraphs 27-60, wherein the buffering agent is selected from the group consisting of monophosphates, diphosphates, sodium mono- and bicarbonates, potassium mono- and bicarbonates, for example, potassium phosphate, dipotassium phosphate, potassium polyphosphates, sodium bicarbonate, trisodium citrate (also referred to as sodium citrate), sodium phosphate, disodium phosphate, trisodium phosphate and sodium polyphosphates, sodium bicarbonate, calcium carbonate, and combinations thereof.

62. The plant-based dairy milk alternative composition of any one of paragraphs 27-61, wherein the buffering agent is dipotassium phosphate present in the composition in an amount of about 0.3% by weight.

63. The plant-based dairy milk alternative composition of any one of paragraphs 27-62, wherein the hydrocolloid agent is selected from the group consisting of locust bean gum, xanthan gum, tragacanth, gum Arabic, acacia gum, gellan gum, and combinations thereof.

64. The plant-based dairy milk alternative composition of any one of paragraphs 27-63, wherein the hydrocolloid agent is locust bean gum.

65. The plant-based dairy milk alternative composition of any one of paragraphs 27-64, wherein the hydrocolloid agent is present in the composition in an amount of 0.01% to 0.1%, by weight.

66. The plant-based dairy milk alternative composition of any one of paragraphs 27-65, wherein the hydrocolloid agent is locust bean gum present in the composition in an amount of about 0.04%.

67. The plant-based dairy milk alternative composition of any one of paragraphs 27-66, wherein the sweetening agent is selected from the group consisting of sucrose, fructose, saccharose, glucose, maltodextrin, dextrose, sorbitol, xylitol, corn syrup, and a combination thereof.

68. The plant-based dairy milk alternative composition of any one of paragraphs 27-67, wherein the sweetening agent is present in the composition in an amount of 0.8% to 1.5%, by weight.

69. The plant-based dairy milk alternative composition of any one of paragraphs 27-68, wherein the sweetening agent is sucrose present in the composition in an amount of about 1.1%.

70. The plant-based dairy milk alternative composition of any one of paragraphs 27-69, wherein the flavor modification agent is different from the sweetening agent and is selected from the group consisting of salts, sweeteners, flavors, flavor modifiers, fruits, fruit extracts, and combinations thereof.

71. The plant-based dairy milk alternative composition of any one of paragraphs 27-70, wherein the flavor modification agent is different from the sweetening agent and is selected from the group consisting of vanilla flavor or extract, dairy artificial flavor, hazelnut artificial flavor, amaretto, cinnamon, chocolate, caramel, and combinations thereof.

72. The plant-based dairy milk alternative composition of any one of paragraphs 27-71, wherein the flavor modification agent is different from the sweetening agent and is present in the composition in an amount of 0.01% to 0.5%, by weight.

73. The plant-based dairy milk alternative composition of any one of paragraphs 27-72, wherein the flavor modification agent comprises vanilla flavor and is present in the composition in an amount of 0.05% to 1.5%, by weight.

74. The plant-based dairy milk alternative composition of any one of paragraphs 27-73, wherein the flavor modification agent comprises sea salt and is present in the composition in an amount of 0.05% to 1.5%, by weight.

The invention will be further illustrated with reference to the following non-limiting Figures and Examples. It will be apparent to those skilled in the art that many changes can be made in the embodiments described without departing from the scope of the present invention. Thus, the scope of the present invention should not be limited to the embodiments described in this application, but only by embodiments described by the language of the claims and the equivalents of those embodiments. Unless otherwise indicated, all percentages are by weight.

### EXAMPLES

### Example 1: Exemplary Formulation

A formulation was prepared that mimics the physical characteristics, including viscosity and friction coefficient, of dairy milk. To evaluate the performance of the composition compared to the performance of dairy milk, samples of the composition were prepared and evaluated by an expert sensory (organoleptic) panel. As a standard for dairy milk-like characteristics, natural dairy milk was used to compare with the plant-based dairy milk alternative composition. The formulation contained the ingredients and amounts listed in Table 1.

TABLE 1

| Ingredient | Weight Percent |
|---|---|
| Plant-based milk base composition: plant protein | 5.61 |
| source, vegetable oil, sweetener, emulsifying agent, | |
| micronutrient blend, buffer, hydrocolloid, salts, | |
| flavoring agent(s) | |
| Inulin (average DP 10) | 1.0 |
| Inulin (average DP > 22) | 0.5 |
| Water | Qs to 100 |
| Total | 100.0 |

### Example 2: Exemplary Formulation Including Oat Concentrate and Coconut Cream

A second formulation including oat concentrate and coconut cream was prepared to mimics the physical characteristics, including viscosity and friction coefficient, of dairy milk. Similar to the organoleptic testing of the formulation of Example 4, the performance of the composition compared to the performance of dairy milk was evaluated by an expert sensory (organoleptic) panel. As a standard for dairy milk-like characteristics, natural dairy milk was used to compare with the plant-based dairy milk alternative composition. The formulation contained the ingredients and amounts listed in Table 2.

TABLE 2

| Ingredient | Weight Percent |
|---|---|
| Plant-based milk base composition: plant protein | 6.59 |
| source, vegetable oil, sweetener, emulsifying agent, | |
| micronutrient blend, buffer, hydrocolloid, salts, | |
| flavoring agent(s) | |
| Inulin (average DP 10) | 1.0 |
| Inulin (average DP > 22) | 0.15 |
| Water | Qs to 100 |
| Total | 100.0 |

### Example 3: Preparation of an Aqueous Inulin Composition

Aqueous inulin compositions were prepared as follows.

Commercial grade, edible, inulin solids powder compositions were purchased. A first, low DP inulin solids powder had an inulin content greater than 90%, a free sugars content less than 7%, average saccharide chain length (DP) of 10. A second, high DP inulin solids powder had an inulin content greater than 99.5%, a free sugars content less than 0.3%, average saccharide chain length (DP) greater than 22.

The plant-based dairy milk formulation of Example 1, comprising 1.0%, by weight, short chain inulin (average DP 10), and 0.5%, by weight, long chain inulin (average DP>20), was mixed together with water up to 100% weight. The ingredients were mixed using a high shear mixer. The oil ingredients to be added to the mixture were pre-sheared prior to addition to the mixture. The high temperature melting fats were added directly to the mixture. The liquid mixture was then run through a colloid meal shear pump, in recirculation with a high shear mixer. The mixture was then homogenized (3000 psi) and then cooled prior to thermal treatment. The mixture was pre-heated prior to thermal processing treatment by direct UHT heat treated (135° C. to 145° C. for 3-10 seconds). The mixture was then cooled via flash cooling and homogenized again (2000 psi). The mixture was then cooled further to the filling temperature and filled aseptically.

The plant-based dairy milk formulation of Example 2, comprising 1.0%, by weight, short chain inulin (average DP 10) and 0.15%, by weight, long chain inulin (average DP>20), was mixed together with water up to 100% weight was produced using the same processing steps.

### Example 4: Texture Analysis: Using Inulin Fiber to Attain Texture and Mouthfeel of Dairy Whole Milk

“Viscosity” refers to the resistance to the flow of a substance (usually a liquid). Viscosity is related to the concept of shear force. Viscosity can be understood as the action of different layers of fluid exerting shear forces on each other or other surfaces as different layers of fluid move relative to each other. There are several viscosity measures. The unit of viscosity is Ns/m², known as pascal seconds (Pas). The viscosity can be “kinematic” or “absolute.” Kinematic viscosity is a measure of the velocity at which momentum is transferred through a fluid. The kinematic viscosity is measured by Stokes (St). Kinematic viscosity is a measure of the resistance flow of a fluid under the influence of gravity. If two fluids of equal volume and different viscosities were placed in the same capillary viscometer and flowed by weight, the more viscous fluid would take longer to flow through the capillary than the less viscous fluid takes. For example, if one fluid takes 200 seconds to complete its flow and another fluid takes 400 s, the second fluid is twice as viscous as the first fluid on the scale of kinematic viscosity. The dimension of kinematic viscosity is length²/hour. Generally, the kinematic viscosity is expressed in centistokes (cSt). The SI unit of kinematic viscosity is mm²/s, which is equal to 1 cSt. “Absolute viscosity,” sometimes referred to as “dynamic viscosity” or “simple viscosity,” is the product of kinematic viscosity and fluid density. Absolute viscosity is expressed in units of centipores (cP). The SI unit of absolute viscosity is millipascal-seconds (mPa·s), where 1 cP=1 mPa·s.

Viscosity can be measured, for example, at a given shear rate or at multiple shear rates, by using a viscometer. The “externalized zero shear” viscosity is determined by creating optimal straight lines for the four highest shear points based on the absolute viscosity vs. shear rate plot and linearly extrapolating the viscosities back to zero shear. Alternatively, in the case of Newtonian fluids, the viscosity can be determined by averaging the viscosity values at multiple shear rates. Viscosity can also be measured at a single or multiple shear rate using a microfluidic viscometer (also called flow velocity), where absolute viscosity is the absolute viscosity as the liquid flows along a passage. Derived from changes in pressure. Viscosity is equal to shear stress throughout the shear rate. In some embodiments, the viscosities measured using a microfluidic viscometer are extrapolated from an externalized zero shear viscosity, e.g., a viscosity measured at multiple shear rates using a conical plate viscometer.

“Shear velocity” refers to the rate of change of velocity at which one of the layers of fluid passes over an adjacent layer. The velocity gradient is the rate of change of velocity with distance from the plate. In this simple case, it shows a constant velocity gradient with a shear rate (v₁−v₂)/h in units of (cm/sec)/(cm)=1/sec. Therefore, the unit of shear rate is the reciprocal of seconds, or generally the reciprocal of time. For microfluidic viscometers, changes in pressure and flow velocity are related to shear rate. “Shear velocity” is relative to the speed at which a material deforms. Formulations containing proteins and viscosity reducing agents are typically spindles (i.e., 20 cP samples) appropriately selected by those skilled in the art to accurately measure viscosity within the viscosity range of a conical plate viscometer and sample of interest. Most accurately measured with a CPE40 spindle mounted on a DV2T viscometer (Blockfield)), measured at shear rates in the range of about 0.5 s⁻¹ to about 200 s⁻¹ and micro When measured using a fluid viscometer, it is measured at a shear rate in the range of about 20 s⁻¹ to about 3,000 s⁻¹.

For the classic “Newtonian” fluids commonly used herein, the viscosity is essentially independent of the shear rate. However, in the case of “non-Newtonian fluids,” as the shear rate is increased, the viscosity either decreases or increases, for example, the fluids are either “slip fluidized” or “slip sticky,” respectively. In the case of concentrated (i.e., high concentration) protein solutions, this can be expressed as pseudoplastic shear fluidization behavior, i.e., where the viscosity decreases with shear rate.

Aqueous inulin compositions were prepared by methods described above and viscosity profiles of each composition, as measured using a conical plate viscometer, were compared with dairy whole milk. Mouthfeel, as perceived by human taste testing, was logged and compared with viscosity profiles. FIG. 1 shows the viscosity profile for whole milk and three aqueous inulin compositions:
2% short chain inulin (aqueous inulin composition comprising 2% inulin, average DP 10);
1% short chain inulin (aqueous inulin composition comprising 1% inulin, average DP 10);
2% mixed short and long chain inulin (aqueous inulin composition comprising 1.5% inulin, average DP 10, and 0.5% inulin, average DP>22).

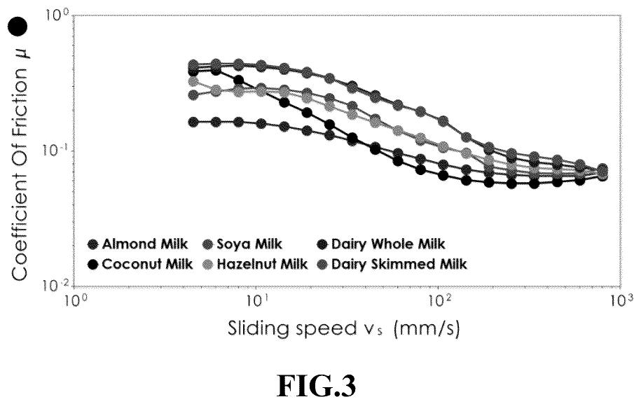

FIG. 3 shows viscosity profiles for whole milk, skimmed milk and four commercial plant-based milk substitute products: almond milk, soya milk, coconut milk, and hazelnut milk.

The viscosity profiles (FIG. 1 and FIG. 3) indicate that the viscosity of the tested aqueous inulin compositions does not perfectly match whole milk. Similarly, commercial plant-based milk substitutes mirror but do not match whole and skimmed dairy milks. Yet organoleptic “mouthfeel” of the 2% mixed Low and High DP inulin composition was rated closest to whole dairy milk, indicating that the perception of texture is not solely determined by viscosity.

### Example 5: Comparison of Coefficient of Friction of Plant-Based Beverages

Viscosity/Shear Profiling entails subjecting a material to a range of shear conditions and observing its viscosity throughout. From the resulting “flow curve” viscosity at any relevant shear rates or stresses and the degree of non-Newtonian (typically shear thinning) behavior exhibited by a material can be identified and quantified. Controlled rate viscosity profiles, where shear rate is swept across mid to high shear rates, are good for obtaining a rapid viscosity profile to correlate to a range of handling conditions, particularly where a material is forced to flow at certain rates through the action of pumps, coating equipment, or manually applied forces.

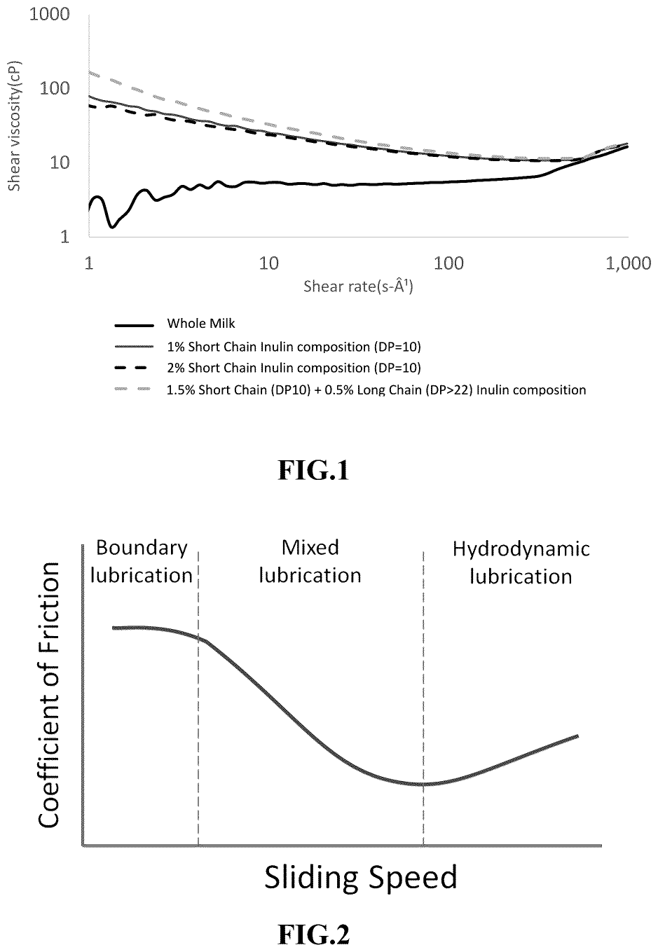

Rheology studies the flow and deformation of films of materials separating surfaces in relative motion. Tribology, on the other hand, is the study of the friction, lubrication and wear of interacting surfaces, i.e., surfaces in close contact. The term bio-tribology relates specifically to the interaction of soft, biological surfaces. Unlike rheology testing, where the sample under test is held in a defined gap between surfaces moving relative to each other, tribology testing entails bringing those surfaces into contact under a defined pressure and sliding one against the other, measuring the frictional drag over a range of sliding speeds. The surfaces and/or any applied lubricating liquid form the test sample. Tribology results are often displayed in the form of a Stribeck curve such as that shown in FIG. 2.

The Stribeck curve is typically composed of three regions. At low speeds the surfaces are in close contact with asperities (surface roughness features) interlocking. Under these conditions lubrication is low, so friction is high. As sliding speed is increased, the lubricant entrained between the upper and lower surfaces creates hydrodynamic lift, resulting in increasing separation of the surfaces and subsequent decreasing frictional drag. Lubrication at this stage is known as mixed boundary-hydrodynamic lubrication. Eventually, as sliding speed is increased, a complete separation of the surfaces ensues. Friction reaches a minimum at this stage and the final part of the Stribeck curve anatomy is reached: hydrodynamic lubrication. From the key features of the Stribeck curve metrics are derived that clearly differentiate between materials of differing lubricating qualities. For thick films, rheology dominates the handling and spreading characteristics, whereas for thin films, tribology takes over, influencing slipperiness and friction reduction. For example, the spreading of a topical product onto the skin, involves the progressive decrease of its film thickness throughout the application process. In fact, this time-dependent transition from a thicker to thinner film occurs in many situations where biological surfaces interact, for example, during oral processing of foods and beverages. Rheological profiling can therefore illuminate the early stages of the material usage and tribology can inform the latter stages.

For the present analysis of plant-based dairy milk alternative compositions according to this disclosure, liquid plant-based beverages including proteins, plant oils, and stabilizers, with and without inulin content, were prepared. Coefficient of friction at 10 mm/s was determined for each beverage. Beverage descriptions and coefficient of friction are presented in Table 3. Viscosity at both 1/1s and 1/1000 s were also tested for each of these plant-based beverages and the results are shown in Table 4.

| | | | | Oat | u Coefficient |
|---|---|---|---|---|---|
| | | | | Concentrate | of |
| | | | Inulin | & Coconut | Friction |
| | | | (yes/ | Cream | at 10 |
| Sample | Description | Protein | no) | (yes/no) | mm/s |
| A | Plant Based Beverage containing | 0.5% | yes | no | 0.502 |
| | soy protein isolate, coconut oil, | | | | |
| | sunflower oil, inulin, among other | | | | |
| | stabilizing gums | | | | |
| B | Plant Based Beverage containing | 0.5% | yes | yes | 0.34 |
| | pea protein isolate, coconut oil, | | | | |
| | sunflower oil, coconut cream, oat | | | | |
| | concentrate, inulin, among other | | | | |
| | stabilizing gums | | | | |
| C | Oat based beverage. | | no | no | 0.261 |
| D | Plant Based Beverage containing | 1.98% | yes | yes | 0.494 |
| | soy protein isolate, coconut oil, | | | | |
| | sunflower oil, coconut cream, oat | | | | |
| | concentrate, inulin, among other | | | | |
| | stabilizing gums | | | | |
| E | Plant Based Beverage containing | 3.9% | yes | yes | 0.521 |
| | soy protein isolate, coconut oil, | | | | |
| | sunflower oil, coconut cream, oat | | | | |
| | concentrate, inulin, among other | | | | |
| | stabilizing gums | | | | |
| H | High protein soy beverage | | | | 0.359 |
| I | Dairy Whole Milk | | | | 0.433 |

TABLE 4

| | Viscosity at 1 s\hat{ }(−1) | Viscosity at 1000 s\hat{ }(−1) |
|---|---|---|
| Sample | (mPa · s) | (mPa · s) |
| A | 51.6 | 3.25 |
| B | 50.3 | 3.27 |
| C | 25.8 | 2.91 |
| D | 53.6 | 3.59 |
| E | 43.5 | 4.37 |
| H | 89 | 15 |
| I | 69.5 | 1.95 |

These data demonstrate that the addition of inulin to these plant-based beverages increases the coefficient of friction and viscosity at 1/is to more closely resemble that of dairy whole milk.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

1. A plant-based texturizing fiber composition comprising a combination of long chain and short chain inulin.

2. The texturizing fiber composition of claim 1, wherein the long chain inulin has an average degree of polymerization (DP) greater than 20.

3. The texturizing fiber composition of claim 1, wherein the long chain inulin has an average degree of polymerization (DP) within the range of 20 to 60.

4. (canceled)

5. (canceled)

6. (canceled)

7. The texturizing fiber composition of claim 1, wherein the short chain inulin has an average degree of polymerization (DP) less than 12.

8. The texturizing fiber composition of claim 1, wherein the short chain inulin has an average degree of polymerization (DP) within the range of 3 to 12.

9. (canceled)

10. (canceled)

11. (canceled)

12. (canceled)

13. (canceled)

14. (canceled)

15. The texturizing fiber composition of claim 1, wherein the short and long chain inulin are present in a w/w ratio of 1:0.15-2:1.

16. (canceled)

17. (canceled)

18. (canceled)

19. (canceled)

20. (canceled)

21. (canceled)

22. The texturizing fiber composition of claim 1, wherein the coefficient of friction at 10 mm/s of the composition is about 0.2 to about 0.6.

23. (canceled)

24. (canceled)

25. (canceled)

26. (canceled)

27. A plant-based dairy milk alternative composition comprising:
a) 80-99% w/w water;
b) 0.0001-4% w/w a vegetal fat;
c) 0.0001-5% w/w a plant protein; and
d) 0.0001%-5% w/w a texturizing fiber comprising a combination of long chain and short chain inulin;
e) 0.0001%-5% w/w a buffering agent;
f) optionally, 0.001-1% w/w a hydrocolloid agent;
g) optionally, 0.0001%-5% w/w a sweetening agent;
h) optionally, 0.0001% to 5% w/w a flavor modification agent,
wherein the friction coefficient of the composition is 0.2-0.6 at 10 mm/s sliding speed.

28. The plant-based dairy milk alternative composition of claim 27, wherein the composition is an oil in water emulsion.

29. The plant-based dairy milk alternative composition of claim 1, wherein the friction coefficient of the composition is 0.3-0.5 at 10 mm/s sliding speed.

30. The plant-based dairy milk alternative composition of claim 27, wherein the viscosity of the composition between about 45 mPa·s and about 55 mPa·s, at 1 s⁻¹.

31. The plant-based dairy milk alternative composition of claim 27, wherein the viscosity of the composition between about 2.9 mPa·s and about 3.5 mPa·s, at 1000 s⁻¹.

32. The plant-based dairy milk alternative composition of claim 1, wherein the long chain inulin has an average degree of polymerization (DP) greater than 20.

33. The plant-based dairy milk alternative composition of claim 27, wherein the long chain inulin has an average degree of polymerization (DP) within the range of 20 to 60.

34. (canceled)

35. (canceled)

36. (canceled)

37. The plant-based dairy milk alternative composition of claim 27, wherein the short chain inulin has an average degree of polymerization (DP) less than 12.

38. The plant-based dairy milk alternative composition claim 27, wherein the short chain inulin has an average degree of polymerization (DP) within the range of 3 to 12.

39. (canceled)

40. (canceled)

41. (canceled)

42. (canceled)

43. (canceled)

44. (canceled)

45. The plant-based dairy milk alternative composition of claim 27, wherein the short and long chain inulin are present in a w/w ratio of 1:0.15-2:1.

46. (canceled)

47. (canceled)

48. The plant-based dairy milk alternative composition of claim 27, wherein the coefficient of friction at 10 mm/s of the composition is about 0.2 to about 0.6.

49. (canceled)

50. (canceled)

51. (canceled)

52. (canceled)

53. The plant-based dairy milk alternative composition of claim 27, wherein the vegetal fat is a combination of coconut oil and sunflower oil.

54. (canceled)

55. (canceled)

56. (canceled)

57. The plant-based dairy milk alternative composition of claim 27, wherein the plant protein is protein from soybeans.

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)
